(19) United States
(12) Patent Application Publication
(10) Pub. No.: US 2025/0126569 A1
(43) Pub. Date: Apr. 17, 2025

(54) UPLINK TRANSMISSION POWER MANAGEMENT TECHNIQUE

(71) Applicant: Telefonaktiebolaget LM Ericsson (publ), Stockholm (SE)

(72) Inventors: Muhammad Ali KAZMI, Reston, VA (US); Venkatarao GONUGUNTLA, Sundbyberg (SE)

(73) Assignee: Telefonaktiebolaget LM Ericsson (publ), Stockholm (SE)

(21) Appl. No.: 18/727,526

(22) PCT Filed: Jan. 10, 2023
(86) PCT No.: PCT/EP2023/050477

§ 371 Date: Jul. 9, 2024

(30) Foreign Application Priority Data
Jan. 10, 2022 (IN) 202241001240

(51) Int. Cl. H04W 52/14; H04W 52/36

(52) U.S. Cl. CPC H04W 52/146; H04W 52/367

(57) ABSTRACT

A technique for an uplink transmit power management, UTPM, procedure is described. As to a method aspect of the technique performed by a radio device a timing relation between a timing of at least one uplink gap, UL gap (602), for the UTPM procedure and a timing of at least one UL signal (604) belonging to a procedure in a first set of procedures, PS1, is determined. The at least one UL gap (602) is selectively used for the UTPM procedure depending on the determined timing relation.

### TECHNICAL FIELD

The present disclosure relates to a technique for uplink transmission power management. More specifically, and without limitation, methods and devices are provided for uplink transmission power management of a radio device and for configuring such a radio device.

### BACKGROUND

The Third Generation Partnership Project (3GPP) has specified technical means for uplink transmission power management (UTPM) such as power management maximum power reduction (P-MPR) at a radio device referred to as user equipment (UE), e.g. for Fourth Generation (4G) Long Term Evolution (LTE) and Fifth Generation (5G) New Radio (NR).

High frequencies such as millimeter waves (mmWave) in bands of the frequency range 2 (FR2) may be absorbed by (or colloquially: conduct) a human body. In order to prevent the mmWave from being absorbed by (or colloquially: conducting) the human body, a maximum permissible exposure (MPE) limitation is introduced. When the MPE limit is reached, the UE will perform power management maximum power reduction (P-MPR) and reduce the uplink (UL) transmit power of the UE. A mechanism to determine the MPE limit is based on the uplink duty cycle. When uplink duty cycle over a certain duration is more than a threshold, MPE limit is assumed to be reached and P-MPR is applied. The duty cycle can be expressed in terms of a ratio of UL time resources to a total number of time resources during a certain time period. The ratio may further be expressed in percentage. The total number of time resources may comprise a sum of UL time resources and downlink (DL) time resources. Examples of time resources are symbols, slots, subframes, etc.

When the MPE limit is reached, power control (i.e. UTPM) is performed through P-MPR. One method to compute the MPE is through UL duty cycle. Another method to compute the MPE is through body proximity sensing (BPS). Using the BPS method, the UE senses its proximity to a human body and when the calculated power of the sensing signal is more than certain threshold for a period of time, transmit power control (i.e. UTPM) is performed by means of the P-MPR.

The UE is configured by the network (e.g., its serving network node) with an UL gap pattern (ULGP) for UL transmit (Tx) power management (UTPM, e.g., P-MPR) of the UE. When the UE is configured with UL gaps, the UE cannot transmit on the UL and uses the gap duration for BPS and for UTPM at the UE.

The UL gaps are configured as periodic gaps. Consequently, there can occur scenarios in which at least one UL gap overlaps with one or more critical UL signals. Hence, the UE taking the UL gap at these instances rather than transmitting the critical UL signals, the performance of an NR system can be severely affected.

### SUMMARY

Accordingly, there is a need for an uplink transmission power management technique that is less detrimental for at least some critical UL signals.

As to a first method aspect, a method performed by a radio device for an uplink transmit power management (UTPM) procedure is provided. The method comprises or initiates determining a timing relation between a timing of at least one uplink gap (UL gap) for the UTPM procedure and a timing of at least one UL signal belonging to a procedure in a first set of procedures (PS1). The method further comprises or initiates selectively using the at least one UL gap for the UTPM procedure depending on the determined timing relation.

The first method aspect may be implemented alone or in combination with any one of the claims 1 to 15.

The first method aspect may be performed by a radio device, e.g., served by a network node (e.g., a network node of a random access network, RAN).

By determining the timing relation of the respective UL gaps relative to (e.g., critical) UL signals, embodiments of the technique enable the radio device to take these UL signals into account when selectively using the corresponding UL gaps for its UTMP.

The radio device may be configured to perform at least one of a procedure in the PS1 (which may include transmitting the at least one UL signal) and the UTPM procedure (i.e., a third set of procedures, PS3).

Herein, “at least one” (e.g., the at least one UL signal) may relate to the case of “exactly one” (e.g., one UL signal) or may encompass “a plurality” (e.g., a plurality of UL signals).

The radio device (e.g., according to the first method aspect) may be configured with at least one UL gap pattern (ULGP) comprising the at least one UL gap for performing the UTPM procedure.

The ULGP may comprise one or more UL gaps (including the at least one UL gap) for which the timing relation is determined and which is selectively used for the UTPM procedure.

The UTPM procedure (e.g., according to the first method aspect) may comprise at least one of calibration or self-calibration of a power amplifier (PA) of the radio device; a proximity detection or body proximity sensing (BPS) at the radio device, optionally comprising transmitting a radar signal; a power management maximum power reduction (P-MPR) of a transmit power of the radio device; and a P-MPR that depends on a proximity of a body to the radio device.

The at least one UL gap (e.g., according to the first method aspect) for performing the UMTP may be a gap in an UL transmission of the radio device.

The radio device (e.g., according to the first method aspect) may transmit an UL signal when the at least one UL gap is not used for the UTPM procedure.

The radio device (e.g., according to the first method aspect) may determine whether or not to use the at least one UL gap based on the determined timing relation, and optionally, a priority of the UL signal.

The PS1 or each procedure in the PS1 or the at least one UL signal belonging to the procedure in the PS1 (e.g., according to the first method aspect) may be associated with a PS1 priority that is higher than a PS3 priority.

If the at least one UL gap is not used according to the selectivity depending on the determined timing relation, the radio device may cancel the at least one UL gap and/or may transmit (in the at least one UL gap) the at least one UL signal belonging to the procedure in the PS1.

The radio device (e.g., according to the first method aspect) may cancel the at least one UL gap and/or transmits the at least one UL signal belonging to the procedure in the PS1 in the at least one UL gap, if at least one of the following conditions is fulfilled if the at least one UL signal belonging to the procedure in the PS1 overlaps in time with the at least one UL gap; if the at least one UL gap occurs during the procedure in the PS1; and if the at least one UL signal belonging to the procedure in the PS1 and the UL gap are close in time to each other or are closer in time to each other than a predefined threshold.

Herein, “overlaps” or “overlap” or “overlapping” may encompass “at least partially overlaps”, etc. or “fully overlaps”, etc. For example, a condition may be: if the at least one UL signal belonging to the procedure in the PS1 at least partially overlaps in time with the at least one UL gap.

The radio device (e.g., according to the first method aspect) may perform, or may be configured to perform, one or more procedures in a second set of procedures (PS2). Each procedure in the PS2 may comprise transmitting at least one UL signal belonging to the respective procedure in the PS2. A PS2 priority may be lower than the PS1 priority and/or lower than a or the PS3 priority, optionally wherein the PS2 priority is associated with at least one or each of the PS2; the one or more procedures in the PS2; each procedure in the PS2; and the UL signal of the PS2.

The radio device (e.g., according to the first method aspect) may perform the UTPM procedure or one or more UTPM procedures in the PS3 and/or drops or postpones the transmission of the at least one UL signal belonging to a procedure in the PS2 in the at least one UL gap, if at least one of the following conditions is fulfilled: if the at least one UL signal belonging to the procedure in the PS2 overlaps in time with the at least one UL gap; if the at least one UL gap occurs during the procedure in the PS2; and if the at least one UL signal belonging to the procedure in the PS2 and the UL gap are close in time to each other or are closer in time to each other than a predefined threshold.

Herein, “overlaps” or “overlap” or “overlapping” may encompass “at least partially overlaps”, etc. or “fully overlaps”, etc. For example, a condition may be: if the at least one UL signal belonging to the procedure in the PS2 at least partially overlaps in time with the at least one UL gap.

The PS3 priority (e.g., according to the first method aspect) may be associated with at least one or each of the at least one UL gap; the ULGP; and the one or more UL gaps of the ULGP. The PS3 priority may be associated with at least one of, or a third set of procedures, PS3, comprising at least one of the UTPM procedure; the UTPM procedure performed during UL gaps; and a procedure that is related to the UTPM and/or performed during UL gaps.

The PS3 priority may be associated with the PS3.

The procedure related to the UTPM may also be referred to as UTPM-related procedure.

The UTPM procedure or the UTPM-related procedure may be performed during one or more UL gaps (e.g., of the ULGP) other than the at least one UL gap.

The PS1 (e.g., according to the first method aspect) may comprise at least one of the following procedures a cell change; a cell selection; a handover (HO); a dual active protocol stack HO (DAPS HO); a conditional HO (CHO); transmitting emergency information; transmitting an UL signal related to a beam failure recovery; a random access procedure during a cell change; a random access channel (RACH) transmission for acquisition of synchronization, optionally a timing 30 advance (TA); a random access channel (RACH) transmission upon expiry of a time alignment timer (TAT); a radio resource control (RRC) reestablishment; an RRC connection release, optionally with redirection; activation of a secondary cell (SCell); deactivation of an SCell; dormancy of an SCell; transmitting a channel state information (CSI) report, and/or a channel quality indicator (CQI); transmission of positioning measurement report; UL transmission after or based on the outcome of a clear channel assessment (CCA) procedure on a carrier subject to CCA; and attempting transmission in an unlicensed carrier, optionally when exceeding a predefined number of CCA failures. The at least one UL signal belonging to the respective procedure in the PS1 may comprise or may be indicative of at least one of emergency information; a beam failure recovery; a random access preamble, RAP; a RAP for acquisition of synchronization, optionally a TA; an RRC reestablishment request; a response to a command for activation of an SCell; a CSI report and/or a CQI; a positioning measurement report.

The method (e.g., according to the first method aspect) wherein at least one of the least one UL signal belonging to the or each procedure in the PS1 and the least one UL signal belonging to the or each procedure in the PS2 may be performed in a frequency range 2 (FR2) or in a frequency range from 24250 MHz to 71000 MHz, or in a frequency range FR2-1, or in a frequency range from 24250 MHz to 52600 MHz, or in a frequency range FR2-2, or a frequency range from 52600 MHz to 71000 MHz, or in millimeter wave band, or in a frequency range 3 (FR3) or in a frequency range from 7125 MHz and 24250 MHz.

The method (e.g., according to the first method aspect) wherein a signal belonging to the UTPM procedure or each procedure in the PS3 may be a radio detection and ranging signal, radar signal. The UTPM procedure or each procedure in the PS3 may use in the at least one UL gap a frequency range outside of at least one of the least one UL signal belonging to the or each procedure in the PS1 and the least one UL signal belonging to the or each procedure in the PS2.

The UL signal (e.g., according to the first method aspect) may be transmitted, or may be to be transmitted, from the radio device to a network node, optionally serving the radio device.

As to a second method aspect, a method performed by a network node for configuring a radio device for an uplink transmit power management (UTPM) procedure is provided. The method comprises or initiates determining, or configuring the radio device to determine, a timing relation between a timing of at least one uplink gap (UL gap) for the UTPM procedure and a timing of at least one UL signal belonging to a procedure in a first set of procedures (PS1). The method further comprises or initiates selectively scheduling the radio device with the at least one UL signal during the at least one UL gap depending on the determined timing relation or configuring the radio device to selectively use the at least one UL gap for the UTPM procedure depending on the determined timing relation.

The second method aspect may be implemented alone or in combination with any one of the claims 16 to 18.

The second method aspect may be performed by a network node, e.g., serving the radio device (e.g., in a RAN).

The second method aspect may further comprise any feature and/or any step disclosed in the context of the first method aspect, or a feature and/or step corresponding thereto, e.g., a receiver counterpart to a transmitter feature or step.

The radio device (e.g., according to the first or the second method aspect) may be scheduled with the at least one UL signal belonging to the procedure in the PS1 in the at least one UL gap, if at least one of the following conditions is fulfilled if the at least one UL signal belonging to the procedure in the PS1 overlaps in time with the at least one UL gap; if the at least one UL gap occurs during the procedure in the PS1; and if the at least one UL signal belonging to the procedure in the PS1 and the UL gap are close in time to each other or are closer in time to each other than a predefined threshold.

Herein, “overlaps” or “overlap” or “overlapping” may encompass “at least partially overlaps”, etc. or “fully overlaps”, etc. For example, a condition may be: if the at least one UL signal belonging to the procedure in the PS1 at least partially overlaps in time with the at least one UL gap.

The method (e.g., according to the second method aspect) may further comprise the features or any one of the steps of the first method aspect.

As to another aspect, a computer program product is provided. The computer program product comprises program code portions for performing any one of the steps of the first and/or second method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the respective method may be encoded in a Field-Programmable Gate Array (FPGA) and/or an Application-Specific Integrated Circuit (ASIC), or the functionality may be provided for download by means of a hardware description language.

As to a first device aspect, a radio device for an uplink transmit power management (UTPM) procedure is provided. The radio device comprises memory operable to store instructions and processing circuitry operable to execute the instructions, such that the radio device is operable to determine a timing relation between a timing of at least one uplink gap (UL gap) for the UTPM procedure and a timing of at least one UL signal belonging to a procedure in a first set of procedures (PS1). The radio device is further operable to selectively use the at least one UL gap for the UTPM procedure depending on the determined timing relation.

The radio device (e.g., according to the first device aspect) may be further operable to perform any one of the steps of the first method aspect.

As to another first device aspect, a radio device for an uplink transmit power management (UTPM) procedure is provided. The radio device is configured to determine a timing relation between a timing of at least one uplink gap (UL gap) for the UTPM procedure and a timing of at least one UL signal belonging to a procedure in a first set of procedures (PS1). The radio device is further configured to selectively use the at least one UL gap for the UTPM procedure depending on the determined timing relation.

The radio device (e.g., according to the first device aspect) may further configured to perform any one of the steps of the first method aspect.

As to another first device aspect, a user equipment (UE) for an uplink transmit power management (UTPM) procedure is provided. The UE is configured to communicate with a base station or with a radio device functioning as a gateway. The UE comprising a radio interface and processing circuitry configured to determine a timing relation between a timing of at least one uplink gap (UL gap) for the UTPM procedure and a timing of at least one UL signal belonging to a procedure in a first set of procedures (PS1). The processing circuitry further configured to selectively use the at least one UL gap for the UTPM procedure depending on the determined timing relation.

The UE (e.g., according to the first device aspect) wherein the processing circuitry may be further configured to execute any one of the steps of the first method aspect.

As to a second device aspect, a network node for configuring a radio device for an uplink transmit power management (UTPM) procedure is provided. The network node comprising memory operable to store instructions and processing circuitry operable to execute the instructions, such that the network node is operable to determine, or to configure the radio device to determine, a timing relation between a timing of at least one uplink gap (UL gap) for the UTPM procedure and a timing of at least one UL signal belonging to a procedure in a first set of procedures (PS1). The network node is further operable to selectively schedule the radio device with the at least one UL signal during the at least one UL gap depending on the determined timing relation or configure the radio device to selectively use the at least one UL gap for the UTPM procedure depending on the determined timing relation.

The network node (e.g., according to the second device aspect) may further operable to perform any one of the steps of the second method aspect.

As to another second device aspect, a network node for configuring a radio device for an uplink transmit power management (UTPM) procedure is provided. The network node is configured to determine, or configuring the radio device to determine, a timing relation between a timing of at least one uplink gap (UL gap), for the UTPM procedure and a timing of at least one UL signal belonging to a procedure in a first set of procedures (PS1). The network node is further configured to selectively schedule the radio device with the at least one UL signal during the at least one UL gap depending on the determined timing relation or configure the radio device to selectively use the at least one UL gap for the UTPM procedure depending on the determined timing relation.

The network node (e.g., according to the second device aspect) may further configured to perform any one of the steps of the second method aspect.

As to another device aspect, a base station for configuring a radio device for an uplink transmit power management (UTPM) procedure is provided. The base station is configured to communicate with a user equipment (UE). The base station comprising a radio interface and processing circuitry configured to determine, or configuring the radio device to determine, a timing relation between a timing of at least one uplink gap (UL gap) for the UTPM procedure and a timing of at least one UL signal belonging to a procedure in a first set of procedures (PS1). The base station comprising a radio interface and processing circuitry further configured to selectively schedule the radio device with the at least one UL signal during the at least one UL gap depending on the determined timing relation or configure the radio device to selectively use the at least one UL gap for the UTPM procedure depending on the determined timing relation.

The base station (e.g., according to the second device aspect) wherein the processing circuitry may be further configured to execute any one of the steps of the second method aspect.

As to a system aspect, a communication system is provided. The communication system includes a host computer comprising processing circuitry configured to provide user data. The host computer further comprises a communication interface configured to forward the user data to a cellular network (e.g., the RAN and/or the network node) for transmission to a UE (e.g., the radio device). A processing circuitry of the cellular network is configured to execute any one of the steps of the first and/or second method aspects. Alternatively or in addition, the UE comprises a radio interface and processing circuitry, which is configured to execute any one of the steps of the first and/or second method aspects.

The communication system (e.g., according to the system aspect) may further include the UE.

The radio network (e.g., according to the system aspect) may further comprise a base station, or a radio device functioning as a gateway, which is configured to communicate with the UE.

The base station or the radio device functioning as a gateway (e.g., according to the system aspect) may comprise processing circuitry configured to execute any one of the steps of the second method aspect.

The processing circuitry of the host computer (e.g., according to the system aspect) may be configured to execute a host application, thereby providing the user data. The processing circuitry of the UE may be configured to execute a client application associated with the host application.

In any aspect, the technique may be applied in the context of 3GPP New Radio (NR). Unlike a SL according to 3GPP LTE, a SL according to 3GPP NR can provide a wide range of QoS levels. Therefore, at least some embodiments of the technique can ensure that the UL transmission of the radio device fulfills the QoS of the traffic.

The technique may be implemented in accordance with a 3GPP specification, e.g., for 3GPP release 17 or later. The technique may be implemented based on, or by modifying, at least one of the 3GPP document TS 38.133, version 17.3.0; the 3GPP document TS 38.101-1, version 17.3.0; the 3GPP document TS 38.321, version 16.7.0; and 3GPP TS 38.331, version 16.7.0. Alternatively or in addition, the technique may be implemented based on the 3GPP work item (WI) for release 17: “NR RF requirement enhancements for frequency range 2 (FR2)”.

According to an embodiment of any aspect of the technique, the at least one UL gap may be cancelled when a radio device (e.g., a UE) has one or more higher-priority transmissions overlapping with the at least one UL gap (i.e., UL gap occasions).

In any radio access technology (RAT), the technique may be implemented as a method of UL gap prioritization rules for transmit (TX) power management, e.g., in mmWave frequencies. Alternatively or in addition, the technique may be applied whenever UL gaps are used in the context of at least one of inter-band carrier aggregation (CA) in the frequency range 2 (FR2), body proximity sensing (BPS), power management maximum power reduction (P-MPR), an UL gap length (UGL), an UL gap repetition periodicity (UGRP), UL gap pattern (ULGP), a random access channel (RACH), a handover (HO), and radio resource control (RRC) re-establishment.

Any radio device may be a user equipment (UE), e.g., according to a 3GPP specification.

The radio device and the network node (e.g., a radio access network, RAN) may be wirelessly connected in an uplink (UL) and/or a downlink (DL) through a Uu interface. Alternatively or in addition, a SL may enable a direct radio communication between proximal radio devices, e.g., the remote radio device and the relay radio device, optionally using a PC5 interface.

The radio device and/or the network node and/or the RAN and/or further radio devices may form, or may be part of, a radio network, e.g., according to the Third Generation Partnership Project (3GPP) or according to the standard family IEEE 802.11 (Wi-Fi). The first method aspect and the second method aspect may be performed by one or more embodiments of the radio device and the network node (e.g., the RAN or any base station), respectively.

The RAN may comprise one or more network node (e.g., base stations), e.g., performing the second method aspect. Alternatively or in addition, the radio network may be a vehicular, ad hoc and/or mesh network comprising two or more radio devices, e.g., acting as the remote radio device and/or the relay radio device and/or the further remote radio device.

Any of the radio devices may be a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more network node (e.g., base stations).

The radio device may be wirelessly connected or connectable (e.g., according to a radio resource control, RRC, state or active mode) with the network node and, optionally, a target network node of a handover (HO).

The network node (e.g., base station) may encompass any station that is configured to provide radio access to any of the radio devices. The base stations may also be referred to as cell, transmission and reception point (TRP), radio access node or access point (AP). The base station and/or the relay radio device may provide a data link to a host computer providing the user data to the remote radio device or gathering user data from the remote radio device. Examples for the base stations may include a 3G base station or Node B, 4G base station or eNodeB (eNB), a 5G base station or gNodeB (gNB), a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, and/or a Radio Resource Control (RRC) layer of a protocol stack for the radio communication.

Herein, referring to a protocol of a layer may also refer to the corresponding layer in the protocol stack. Vice versa, referring to a layer of the protocol stack may also refer to the corresponding protocol of the layer. Any protocol may be implemented by a corresponding method.

Any one of the devices, the radio device (e.g., the UE), the network node (e.g., the base station), the communication system or any node or station for embodying the technique may further include any feature disclosed in the context of the method aspect, and vice versa. Particularly, any one of the units and modules disclosed herein may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for a UTPM procedure;

FIG. 2 shows a schematic block diagram of an embodiment of a device for configuring a UTPM procedure;

FIG. 3 shows a flowchart for a method of a UTPM procedure, which method may be implementable by the device of FIG. 1;

FIG. 4 shows a flowchart for a method of configuring a UTPM procedure, which method may be implementable by the device of FIG. 2;

FIG. 5 schematically illustrates a first example of a radio network comprising embodiments of the devices of FIGS. 1 and 2 for performing the methods of FIGS. 4 and 5, respectively;

FIG. 6 schematically illustrates a temporal scheme of selectively using UL gaps when performing the methods of FIGS. 3 and 4;

FIG. 7 shows a schematic block diagram of a radio device embodying the device of FIG. 1;

FIG. 8 shows a schematic block diagram of a network node embodying the device of FIG. 2;

FIG. 9 schematically illustrates an example telecommunication network connected via an intermediate network to a host computer;

FIG. 10 shows a generalized block diagram of a host computer communicating via a base station or radio device functioning as a gateway with a user equipment over a partially wireless connection; and

FIGS. 11 and 12 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

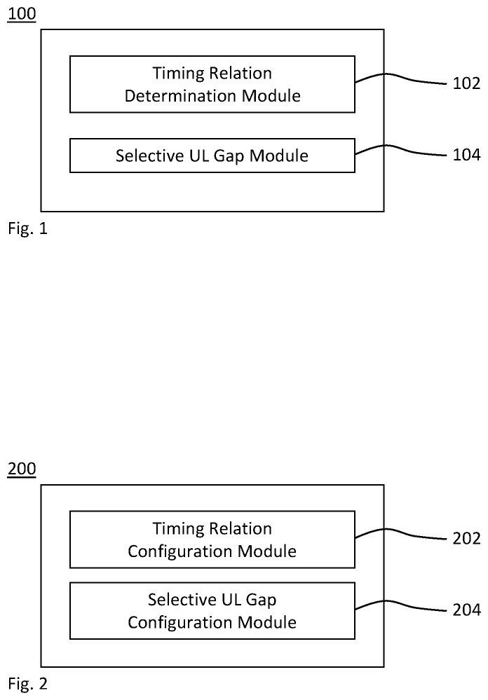

FIG. 1 schematically illustrates a block diagram of an embodiment of a device for an UTPM procedure according to the first device aspect. The device is generically referred to by reference sign 100.

The device 100 comprises the modules indicated in FIG. 1 for performing respective steps of the first method aspect and/or claim 1.

Any of the modules of the device 100 may be implemented by units configured to provide the corresponding functionality.

The device 100 may also be referred to as, or may be embodied by, the radio device (or briefly: UE). The UE 100 and the network node (e.g. gNB) may be in direct radio communication, e.g., at least for transmitting the at least one UL signal belonging to the PS1 and/or PS2. The network node may be embodied by the below device 200.

FIG. 2 schematically illustrates a block diagram of an embodiment of a device for configuring an UTPM procedure according to the second device aspect. The device is generically referred to by reference sign 200.

The device 200 comprises the modules indicated in FIG. 2 for performing respective steps of the second method aspect and/or claim 16.

Any of the modules of the device 200 may be implemented by units configured to provide the corresponding functionality.

The device 200 may also be referred to as, or may be embodied by, the network node (or briefly: gNB or eNB). The gNB 200 and the radio device (e.g. UE) may be in direct radio communication, e.g., at least for receiving the at least one UL signal belonging to the PS1 and/or PS2. The UE may be embodied by the above device 100.

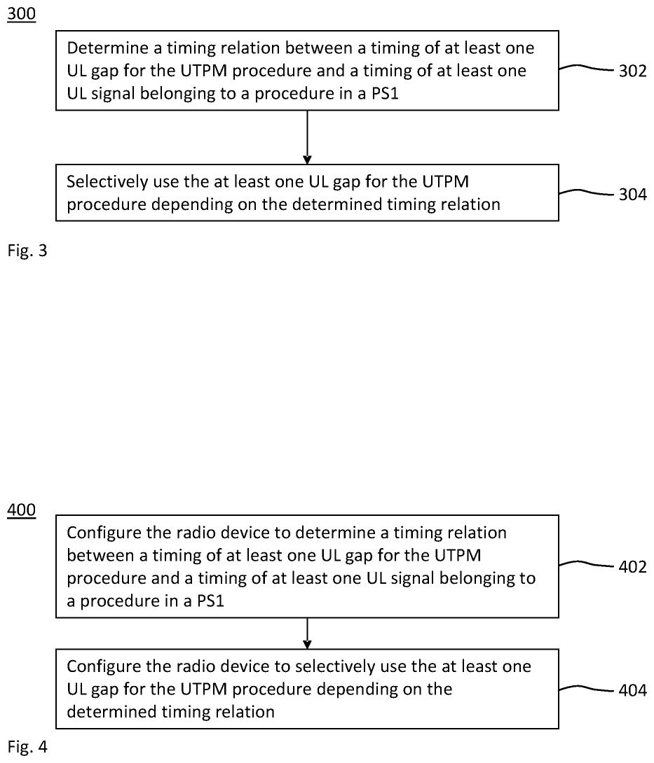

FIG. 3 shows an example flowchart for a method 300 according to the first method aspect and/or claim 1.

The method comprises the steps indicated in FIG. 3 and/or any one of the claims 1 to 15.

The method 300 may be performed by the device 100. For example, the modules 102 and 104 may perform the steps 302 and 304, respectively.

FIG. 4 shows an example flowchart for a method 400 according to the second method aspect and/or claim 16.

The method comprises the steps indicated in FIG. 4 and/or any one of the claims 16 to 18.

The method 400 may be performed by the device 100. For example, the modules 202 and 204 may perform the steps 402 and 404, respectively.

In any aspect, a scenario may comprise a UE 100 configured with at least one UL gap pattern (ULGP) comprising of one or more UL gaps for performing the (e.g., UE) uplink transmit power management (UTPM) procedure.

In the step 302, the UE 100 may determine a timing relation between a timing of at least one UL gap in the ULGP and a timing of at least one uplink signal belonging to at least one procedure in a first set of procedures (PS1). In the step 304, the UE 100 may decide whether (or not) to use the one or more UL gaps for the UL transmit power management (UTPM) procedure (e.g. body proximity detection and/or P-MPR etc.) based on the determined timing relation.

The one or more procedures in PS1 are configured as higher priority compared to the priority of the UL gaps or any UTPM-related procedure performed during the UL gap. One or more procedures not belonging to PS1, may belong to a second set of procedures (PS2). Procedures in PS2 are configured as lower priority compared to the priority of the UL gaps or any UTPM related procedure performed during the UL gap. The one or more procedures that are related to UTPM or use of UL gaps for any UTPM are referred to as a third set of procedures (PS3).

For example, the UE 100 may cancel the UL gap and may instead transmit the UL signal belong to PS1 provided that one or more condition is met: if the UL signal belonging to PS1 overlaps in time with the UL gap, if the UL gap occurs any time during the entire procedure in which the UL signal is transmitted and if the UL signal belonging to PS1 and the UL gap are close in time with respect to each other. The UE may perform one or more UTPM procedures (e.g. PS3) in UL gaps and instead drop or postpone the transmission of UL signal related to PS2 if it (UL signal) overlaps with UL gaps or is close to the UL gap in time.

Examples of procedures in PS1 are cell change (e.g. HO etc.), transmission of one or more critical signals (e.g. emergency information, UL signal related to beam failure recovery, RACH transmission during cell change procedure, RACH transmission for acquisition of synchronization (e.g. TA command), UL signal (e.g. CSI report such as CQI) transmission during Scell activation procedure, transmission of positioning measurement report, UL transmission after or based on the outcome of the CCA procedure on carrier subject to CCA etc.

The technique may be applied to uplink (UL), downlink (DL) or direct communications between radio devices, e.g., device-to-device (D2D) communications or sidelink (SL) communications.

Each of the device 100 and device 200 may be a radio device or a network node (e.g., base station). Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

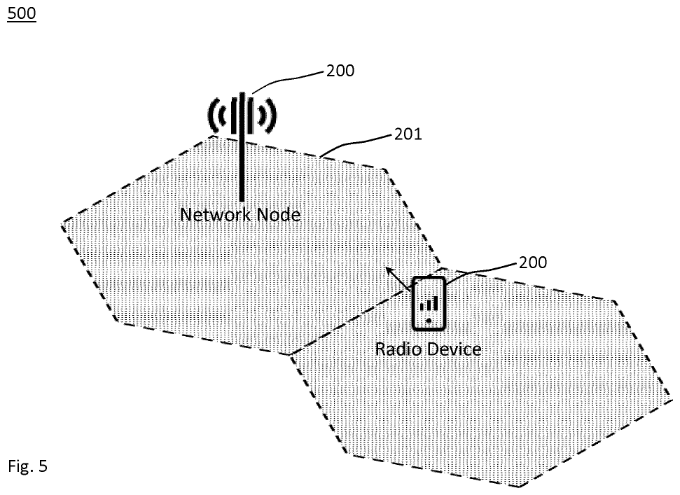

FIG. 5 schematically illustrates an example of a radio network 500 (e.g., a radio access network) comprising embodiments of the radio device 100 and the network node 200. The network node 200 may provide radio access to (e.g., serve) the radio device 100 in at least one cell 201.

The procedure in the PS1 may comprise, or may be triggered by, a cell change (e.g., a HO) as indicated by the arrow in FIG. 5.

Any aspect or embodiment of the technique may be implemented for New Radio (NR) operation and/or in mm wave frequency, optionally using at least one of the following features.

NR can be operated in wide range of frequency namely, FR1, FR2. FR1 consists of frequency bands in the range from 410 MHz to 7125 MHz. FR1 is also called sub 6 GHz. FR2 is further divided as FR2-1 and FR2-2. Where FR2-1 is from 24250 MHZ-52600 MHz and FR2-2 is above 71.6 GHz. The frequency range of FR2 are also called as above n “above-6-GHz range” and may also referred as a millimeter wave (mmWave) bands/frequency.

Any aspect or embodiment of the technique may be implemented for carrier aggregation (CA), i.e., CA operation, optionally using at least one of the following features.

In Carrier Aggregation (CA) the UE is configured with two or more carriers from the same frequency band or different frequency band and the UE can have multiple serving cells e.g., PCell and one or more SCells. If all the aggregated carriers are on the same band, it is called as intra-band CA and if the aggregated carriers on different bands, it is called as inter-band CA.

Any aspect or embodiment of the technique may be implemented for Power Management Maximum Power Reduction (P-MPR), e.g. as an example of the UTPM, optionally using at least one of the following features.

High frequencies such as mmWave in FR2 band may conduct a human body. In order to prevent the mmWave from conducting the human body, a maximum permissible exposure (MPE) limitation is introduced. When the MPE limit is reached the UE will perform power management maximum power reduction (P-MPR) and reduce the UE UL transmit power. The mechanism to determine the MPE limit is based on the uplink duty cycle. When uplink duty cycle over a certain duration is more than a threshold, MPE limit is assumed to be reached and P-MPR is applied. The duty cycle can be expressed in terms of ratio of UL time resources to total number of time resources during certain time period. The ratio may further be expressed in percentage. The total number of time resources comprises sum of UL and DL time resources. Examples of time resources are symbols, slots, subframes etc.

The UE maximum power, which is also called as UE maximum output power (Pmax) or UE nominal output power may be defined by the UE power class (PC). The UE PC may further be expressed in terms of maximum total radiated power (TRP) and maximum equivalent isotropically radiated power (EIRP) in mmWave. Examples of UE PCs are PC1, PC2, PC3, PC4, PC5 etc. For example, the max TRP and max EIRP for UE PC 1 are 35 dBm and 55 dBm respectively. The max TRP and max EIRP for both UE PC2 and UE PC3 are 23 dBm and 43 dBm respectively.

Alternatively or in addition, the PCs may be specified according to the 3GPP document TS 38.101 or TS 38.101-1, version 17.3.0, clauses 6.2.1 and 6.2.2.

Any aspect or embodiment of the technique may selectively use the UL gaps for self-calibration and monitoring, e.g. as an example of the UTPM, optionally using at least one of the following features.

As discussed in above section, when MPE limit is reached power control is performed through P-MPR. One of the method to compute MPE is through UL duty cycle and the other method to compute the MPE is through body proximity sensing (BPS). Using BPS method, the UE 100 senses its proximity to human body and when the calculated power of the sensing signal is more than certain threshold for a period of time, transmit power control is performed through P-MPR.

Alternatively or in addition, the UE 100 uses single RF chain for BPS and NR UL transmissions. Since same RF chain is used, UE cannot transmit NR UL and sensing signal at the same time and UE needs transmission gap on NR UL transmissions to transmit sensing signal. Since the gap occurs on UL transmissions, these gaps are called UL gaps and since they are used for UE self-calibration and monitoring, these gaps are called UL gaps for self-calibration and monitoring.

In any aspect or embodiment of the technique, the UL gap may be configured and/or activated according to at least one of the following steps and features. Gaps on the UL should be known to both UE and network. Hence the UL gaps are configured by the network node using RRC configuration upon UE request. When the gaps are not in use, the network node (e.g., gNB) can de-configure them using signaling e.g., the RRC configuration. Support of UL gaps for TX power management (P-MPR) is a UE capability of the UE and it should be indicated by the UE to the network node (e.g., gNB). Since the UL gaps is a UE capability, different UEs need not to support the same UL gap configuration. Hence, multiple configurations of UL gaps may (or may have to) be configured (e.g., in one cell) for different UEs.

In any aspect or embodiment of the technique, the UL gap may be configured according to an UL gap configuration using at least one of the following steps and features.

Currently, the following 4 gap configurations are introduced. Each UL gap pattern (ULGP) is characterized by UGL and UGRP. UGL (UL gap length) indicates the number of consecutive static UL slots configured as UL gap per UGRP (UL gap repetition periodicity).

| | UGL (ms) | UGRP (ms) |
|---|---|---|
| ULGP#0 | 1.0 | 20 |
| ULGP#1 | 1.0 | 40 |
| ULGP#2 | 0.5 | 160 |
| ULGP#3 | 0.125 | 5 |

Once the UL gap is configured and activated, the UE will perform BPS sensing only in the consecutive static UL slot within UGL, i.e., no DL slot or special slot will be used as UL gap.

In any aspect or embodiment of the technique, at least one or the procedure in the PS1 may comprise a random access procedure, optionally using at least one of the following features or steps.

All the UE 100 transmitting to the same network node (e.g. gNB, base station 200 etc.) need to be in synchronization to avoid causing interference to one another. To achieve this all the UEs need to acquire the transmit timing w.r.t the downlink timing before the UL transmission. In general UE transmit timing will be advanced w.r.t downlink timing so that all the UEs' transmissions in the same cell can be received at the same time at the base station e.g. gNB. UE performs random access procedure to assist the base station to acquire or determine the UE Timing advance (TA). The base station transmits the TA command to the UE. Random access procedure is performed on random access channel (RACH). In NR the UE may be configured by the network to transmit the random access (RA) in a cell (e.g. serving cell or a neighbor cell) using 4-step RA procedure and/or using 2-step RA procedure. If the UE 100 is configured with both RA types, the UE 100 may select and use one of the two RA procedures for RA transmission based on one or more selection criteria e.g. based on signal strength etc.

The timing advance (TA) at the UE 100 is necessary to ensure that the downlink and uplink subframes are synchronized at a base station. From time to time based on the need, the timing advance may be signaled from the base station to the UE and used by the UE to adjust the timing of the UE's transmissions to the base station so that the transmitted signals can reach the base station at the desired time.

The RA transmission is also used by the UE for several other purposes e.g. for accessing a target cell during cell change procedure as described later.

Any aspect or embodiment of the technique may comprise one or more of the following examples of setup and/or change procedures associated with UE feedback in NR in the PS1 or PS2.

The embodiments are applicable to any type of setup and/or change procedures involving at least 2 cells which requires the UE to send an uplink feedback signal in response to receiving one or more messages for setup and/or change procedures. Examples of the feedback signals are measurement reports (e.g. CSI reporting), random access transmission (e.g. due to PDCCH order or expiry of time alignment timer (TAT)), HARQ feedback such as ACK, NACK etc.

The setup procedure comprises for example setting up and/or releasing one or more cells and/or setting up and/or releasing one or more signals (e.g. a beam, TCI state etc) on different cells associated with the UE. Examples of setup procedures are: SCell activation, SCell deactivation, configuration of a serving cell (e.g. SCell), SCell addition, SCell release, direct activation of a serving cell or activation at configuration (e.g. direct SCell activation, direct SpCell activation, combined configuration and activation of serving cell e.g. PSCell addition, etc), configuration or reconfiguration of special cell (SpCell) (e.g. PSCell addition or PSCell release etc), cell group configuration for multi-connectivity (e.g. SCG configuration), cell group activation in multi-connectivity (e.g. SCG activation), TCI state activation, TCI state configuration etc.

The change procedure comprises for example changing one or more cells of the UE e.g. one or more serving cells. The cell change may also be called as cell reconfiguration or reconfiguration of the cell. Examples of cell change procedures are: change of SpCell (e.g. change of PCell, change of PSCell etc), change of multiple SpCells (e.g. change of PCell and PSCell), change of one or more SCells, handover with PSCell change, change of any combinations of one or more serving cells (e.g. change of one or more SpCell and one or more SCells), change of cell group in multi-connectivity (e.g. change in SCG etc), conditional change of SpCell, e.g. conditional handover of PCell, conditional PSCell change, etc. The condition cell change (e.g. conditional HO, conditional SpCell change) is performed by the UE when one or more condition is met e.g. signal level (e.g. RSRP) of target cell becomes larger than signal threshold etc.

Some of the above exemplary procedures are described below. Any aspect or embodiment of the technique may comprise one or more of the below examples in NR in the PS1 or PS2.

Any aspect or embodiment of the technique may comprise an NR handover in the PS1.

When a neighbouring cell becomes stronger than serving cell or for load balancing on the serving cell, serving node can trigger the handover (HO) command. Upon reception of handover command at slot n, UE completes handover to target cell and sends the PRACH preamble no later than n+D_{handover}. Where, D_{handover} is total delay required to perform the handover.

Any aspect or embodiment of the technique may comprise a PSCell (e.g., primary secondary cell) addition in NR in the PS1.

The PSCell is added to setup the SpCell in secondary cell group (SCG) in multi-connectivity operation. Upon receiving PSCell addition command in time resource n, the UE transmits UL signal (e.g. PRACH preamble) towards PSCell no later than in time resource n+T_{config PSCell}, where T_{config PSCell} is the total time to perform the PSCell addition. The UE may also send other UL signals (e.g. in PCell) during the PSCell addition e.g. HARQ feedback signal.

Any aspect or embodiment of the technique may comprise a handover with PSCell change in NR in the PS1.

The HO with PSCell change implies that upon receiving the cell change command (e.g. HO) the UE changes both the PCell and PSCell in DC. Upon completion of the HO with PSCell, the UE sends UL signals (e.g. PRACH pre-amble) in their respective new PCell and new PSCell. The PRACH reception in the new PCell and PSCell enables the network to know that the HO with PSCell has been successful. The UE may also send other UL signals (e.g. in old PCell) during the HO with PSCell change e.g. HARQ feedback signals. Examples of scenarios for HO with PSCell are from EN-DC to EN-DC HO, from NE-DC to NE-DC HO, from NR-DC to NR-DC HO etc.

Any aspect or embodiment of the technique may comprise a SCell activation in NR in the PS1.

The UE 100 may be configured to activate one or multiple SCells (e.g. called as multiple SCell activation) using one or multiple SCell activation commands.

Upon receiving SCell activation command in time resource n, the UE transmits valid CSI report (e.g. CQI with non-zero CQI index) and apply actions related to the activation command for the SCell being activated no later than in time resource n+T_{act, sCell}, where T_{act SCell} is the total time to perform the SCell activation. Upon completion of the SCell activation the UE sends CSI report The UE may also send other UL signals (e.g. in SpCell) the SCell activation e.g. HARQ feedback signals.

In one example the valid CSI report is sent on the SpCell. In another example the valid CSI report is sent on the SCell e.g. SCell which is being activated. For example, the latter case applies when the SCell being activated also has an uplink. In another example the latter case applies when the SCell being activated also has an uplink but is also configured with certain type of UL channel e.g. PUCCH. This may also be called as PUCCH SCell activation.

The SCell activation command may be sent for activating SCell which is already configured, e.g. MAC CE command. In another example the SCell activation command may be sent for both configuring and activating an SCell. This may also be called as direction SCell activation, SCell activation at configuration or reconfiguration etc., e.g. via RRC message.

Any aspect or embodiment of the technique may comprise UL Transmission Configuration Indication (TCI) as the UL signal belonging to the process in the PS1.

A UE 100 may be configured by the network node with active TCI (transmission configuration indication) state for PUCCH (physical uplink control channel) and PUSCH (physical uplink shared channel), respectively. The active TCI indicates for each of the channels which timing reference and spatial relation the UE shall assume for the uplink transmission. The timing reference may be with respect to an SSB index associated with a particular reference DL-RS resource configured by the network node and provided (i.e., transmitted) to the UE.

In this disclosure, the term “node” is used, which may be a network node or a user equipment (UE).

Examples of network nodes are NodeB, base station (BS), multi-standard radio (MSR) radio node such as MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, transmission reception point (TRP), RRU, RRH, nodes in distributed antenna system (DAS), core network node (e.g. MSC, MME etc.), O&M, OSS, SON, positioning node (e.g. E-SMLC), etc.

The non-limiting term UE refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, tablet, mobile terminals, smart phone, laptop embedded equipment (LEE), laptop mounted equipment (LME), USB dongles etc.

The term radio access technology, or RAT, may refer to any RAT e.g. UTRA, E-UTRA, narrow band internet of things (NB-IoT), Wi-Fi, Bluetooth, next generation RAT, New Radio (NR), 4G, 5G, etc. Any of the equipment denoted by the term node, network node or radio network node may be capable of supporting a single or multiple RATs.

The term signal or radio signal used herein can be any physical signal or physical channel. Examples of DL physical signals are reference signal (RS) such as PSS, SSS, CSI-RS, DMRS signals in SS/PBCH block (SSB), discovery reference signal (DRS), CRS, PRS etc. RS may be periodic e.g., RS occasion carrying one or more RSs may occur with certain periodicity e.g., 20 ms, 40 ms etc. The RS may also be aperiodic. Each SSB carries NR-PSS, NR-SSS and NR-PBCH in 4 successive symbols. One or multiple SSBs are transmit in one SSB burst which is repeated with certain periodicity e.g., 5 ms, 10 ms, 20 ms, 40 ms, 80 ms and 160 ms. The term physical channel refers to any channel carrying higher layer information e.g., data, control etc. Examples of physical channels include at least one of PBCH, NPBCH, PDCCH, PDSCH, sPUCCH, sPDSCH, sPUCCH, sPUSCH, MPDCCH, NPDCCH, NPDSCH, E-PDCCH, PUSCH, PUCCH, NPUSCH, etc.

A DL RS (e.g. SSB or CS-RS) may also be called as a DL beam, spatial filter, spatial domain transmission filter, main lobe of the radiation pattern of antenna array etc. The RS or beams may be addressed or configured by an identifier, which can indicate the location of the beam in time in beam pattern e.g. beam index such as SSB index indicate SSB beam location in the pre-defined SSB format/pattern. For example, the term beam used herein may refer to RS such as SSB, CSI-RS etc.

The term multi-carrier operation used herein can be either a carrier aggregation (CA) or multi-connectivity (MuC) operation. The aggregated carriers in CA or MuC can belong to the same RAT or to different RATs.

The term time resource used herein may correspond to any type of physical resource or radio resource expressed in terms of length of time. Examples of time resources are: symbol, time slot, subframe, radio frame, TTI, interleaving time, slot, sub-slot, mini-slot, SFN cycle, hyper-SFN (H-SFN) cycle etc.

In NR the spectrum is divided into two frequency ranges namely frequency range #1(FR1) and frequency range #2(FR2). Frequencies in FR2 are higher than those in FR1. FR1 is currently defined from 410 MHz to 7125 MHz. FR2 range is currently defined from 24250 MHz to 52600 MHZ. In another example FR2 range can be from 24250 MHz to 71000 MHz, where the frequency range 24250-52600 MHz is called FR2-1 and frequency range 52600-71000 MHz is called FR2-2. The FR2 range is also interchangeably called as millimeter wave (mmWave) and corresponding bands in FR2 are called as mmWave bands. In future more frequency ranges can be specified e.g. frequency range #3 (FR3). An example of FR3 is frequency ranging between 7125 MHz and 24250 MHz.

The term clear channel assessment (CCA) used herein may correspond to any type of carrier sense multiple access (CSMA) procedure or mechanism which is performed by the device on a carrier before deciding to transmit signals on that carrier. The CCA is also interchangeably called CSMA scheme, channel assessment scheme, listen-before-talk (LBT) etc. The CCA based operation is more generally called as contention-based operation. The transmission of signals on a carrier subjected to CCA is also called contention-based transmission. On the other hand, the transmission of signals on a carrier which is not subject to CCA is also called as contention free transmission. The contention-based operation is typically used for transmission on carriers of unlicensed frequency band and contention-free operation is typically used for transmission on carriers of licensed frequency band. But CCA mechanism may also be applied for operating on carriers belonging to licensed band for example to reduce interference. LBT or CCA can be performed, e.g., by UE (prior to UL transmission) and/or base station (prior to DL transmission).

The carrier frequency subject to CCA may refer to a scenario where the UE is configured to operate a signal between the UE and wherein the operation of the signal is subject to CCA. The term “operation of the signal being subject to CCA” may refer to a scenario in which the device before transmitting a signal in a cell (e.g. serving cells of CG1, CG2, etc.) may apply CCA procedure to decide whether the channel is idle or busy i.e. transmit signal if the channel is idle otherwise it defers the transmission. The receiving device (e.g. UE) may further determine whether the signal was transmit or not by the transmitting device (e.g. BS).

For example the UE 100 may determine based on one or more of the following principles:

A first principle relates to autonomous determination by the UE, which may comprise at least one of the following features or steps. The UE 100 may determine that CCA has failed in the downlink (e.g. in the base station transmitting the signal) if the UE is unable to receive a signal or if the signal is unavailable at the UE or the UE determines that the signal is not present or it cannot be detected by the UE. For example the UE may correlate the signal with pre-defined sequences e.g. correlating the SSB expected to be received in certain time-frequency resources with one or more candidate SSBs. If the output or result of the correlation is below certain threshold (Y) then the UE assumes that the signal (e.g. SSB) was not transmitted by the base station due to DL CCA failure. Otherwise, if the output or result of the correlation is equal to above Y then the UE assumes that the signal (e.g. SSB) was transmitted by the base station i.e. DL CCA was successful.

A second principle relates to explicit indication from another node, which may comprise at least one of the following features or steps. In another example the network node (e.g. base station such as PCell in CG1) may transmit the results or outcome of the CCA failures detected in the BS (e.g. serving cell of CG2) to the UE. For example the BS may transmit the outcome or results of the DL CCA in the BS in the last Z1 number of time resources or signals in terms of bitmap to the UE. Each bit may indicate whether the DL CCA was failure or successful. For example 0 and 1 in bit map may indicate that DL CCA was failure and successful respective respectively.

Any of the embodiments described above or in the list of embodiments may be implemented using the following scenario and/or at least one of the features of below detailed embodiments.

A scenario comprises of UE configured with UL gaps by network node to perform UE transmit (Tx) power management (UTPM). The UE may be configured with one of the supported UL gaps from the supported set of UL gap patterns. The supported set of UL gap patterns are ULGP #0, ULGP #1, ULGP #2, ULGP #3.

The UTPM procedure enables the UE to reduce its UE transmit power to reasonable or appropriate level based on the body proximity sensing (BPS) w.r.t the UE location. The UE power reduction may be referred to as P-MPR, which depends on the proximity (closeness) of the body w.r.t the location of the UE. For example, when based on the BPS, the UE applies smaller value of P-MPR (e.g. 1 dB) if the body is far from the UE compared to the value of the P-MPR (e.g. 4 dB) when the body is relatively closer to the UE. The UTPM procedure may therefore also be called as dynamic or semi-static P-MPR, adaptive P-MPR, efficient P-MPR etc. To perform the BPS, in one example, the UE may transmit a radar type signal during the UL gap and further detects the reception (e.g. timing) of the transmitted signal in the same or another UL gap. The radar type signal may be operated on a frequency which may different than the frequency of the UE's cellular operation. Therefore, the term UTPM used herein refer to any one or more procedures which enables the UE to apply P-MPR procedure. The UTPM may include the body proximity sensing or detection procedure, determination and/or application of the UE transmit power reduction e.g. P-MPR etc. The UE may use one or multiple UL gaps in the configured ULGP to determine the P-MPR value e.g. based on combination (e.g. average, max, min, sum, x-th percentile etc.) of the results of the BPS, etc.

If the UE cannot apply UTPM procedure or is not configured with ULGP for the UTPM procedure, then to meet the exposure requirements (e.g. SAR) the UE may apply very conservative value of P-MPR. The conservative value of P-MPR may be a fixed value and/or very large value (e.g. 9 dB) regardless of the body proximity with respect to the UE location.

The detailed embodiments may be described for the UTPM in FR2. But they are applicable to any frequency range.

A UE 100 may or may not support UL gaps for the transmit power management through P-MPR. The UEs which support this feature indicates its capability to network node as a UE capability.

When the UE 100 supports UL gap, the UE 100 may also support MPE reporting, e.g., according to 3GPP release 16. The release 16 MPE reporting as described in TS 38.331, version 16.5.0 is

```
MPE-Config-FR2-r16 ::= SEQUENCE {
  mpe-ProhibitTimer-r16 ENUMERATED {sf0, sf10, sf20, sf50,
  sf100, sf200, sf500, sf1000},
  mpe-Threshold-r16 ENUMERATED {dB3, dB6, dB9, dB12}
}
```

MPE-Config-FR2-r16 is reported as MPE report in the power headroom report (PHR).

Any of the above embodiments or the embodiments in the list of embodiments may implement at least one of the features of the following detailed embodiments. Alternatively or in addition, any one of the following detailed embodiments may be implemented as a described.

A first detailed embodiment relates to a method 300 in a UE 100 of adapting operation in UL gap based on one or more operating procedures.

According to the first detailed embodiment, the UE 100 may be configured with at least one UL gap pattern (ULGP) for performing the UE transmit power management (UTPM) procedure:
Determines a timing relation between a timing of at least one UL gap in the ULGP and a timing of at least one uplink signal belonging to at least one procedure in a first set of procedures (PS1) according to the step 302; and
The UE 100 decides whether to use the one or more UL gaps for the UTPM procedure (e.g., body proximity detection and/or P-MPR etc.) based on the determined timing relation according to the step 304.

Examples of timing relations between the timing of the at least UL gap (Tg) and timing of the at least one UL signal (Ts) in PS1 may comprise at least one of:
Whether the at least one UL gap and the at least one UL signal of PS1 at least partially overlap in time.
Whether the end of the at least one UL gap in time (Tg12) and the start of the at least one UL signal of PS1 in time (Ts11) are separated in time by less than certain threshold (H1).
Whether the end of the at least UL signal of PS1 in time (Ts12) and the start of the at least one UL gap in time (Tg11) are separated in time by less than certain threshold (H2).
Whether any UL gaps of the configured ULGP, occurs during the time duration (Td) of the procedure of PS1 in which the at least one UL signal is transmitted.

Parameters H1 and H2 may be pre-defined or configured by the network node. In one example, H1=H2. In another example, H1H2. The above timing relations further determine whether the UE meets one or more gap-signal proximity (GSP) conditions as described below.

The UE 100 meets at least one gap-signal proximity (GSP) condition provided that one or more of the following criteria is met:
1. If at least one UL gap and the at least one UL signal of PS1 at least partially overlap in time.
2. If |(Tg12-Ts11)|<H1.
3. If |(Tg11-Ts12)|<H2.
4. The at least one UL gap of the configured ULGP, occurs during Td in which the at least one UL signal is transmitted. Td is the time during which at least one procedure in PS1 is performed or expected to be performed by the UE. The at least one UL signal is transmitted during Td or it may meet any one or more GSP conditions 1-3.

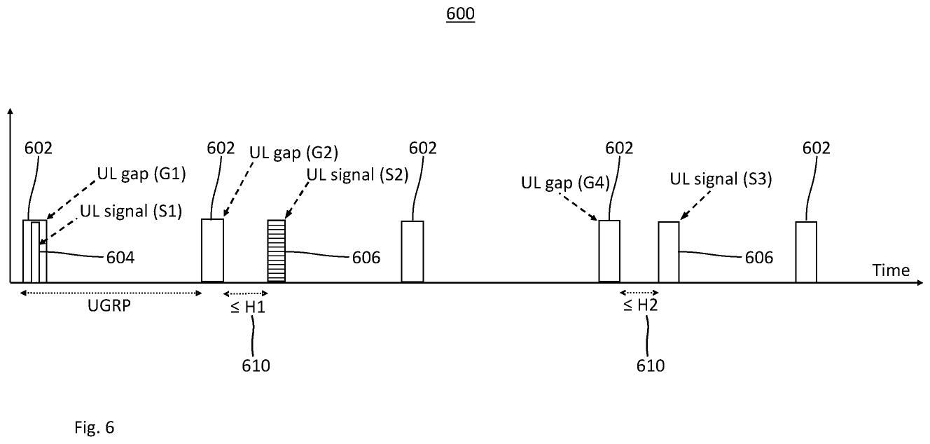

The UL gap cancellation when one or more GSP condition is met is also illustrated with an example in FIG. 6.

Optionally, the UE 100 does not any meet any GSP condition if none of the following criteria is met.

The UE procedures (e.g., the method 300) based on the outcome of the evaluation of the GSP condition may comprise at least one of the following:
The UE 100 may decide not to use the at least one UL gap for the UTPM if the UE determines based on the timing relation that at least one GSP condition is met. For example, the UE does not perform any UTPM in the at least one UL gap. In this case, the UE may further decide to use the at least one UL gap for transmitting the UL signal. For example, the UE 100 may transmit the at least one UL signal for which the UE 100 has met at least one GSP condition. To achieve this objective the UE 100 may not retune its transceiver for creating the UL gap for any UTPM related operation e.g. during the time which at least partially overlap one UL gap or which is close to the UL signal in time (e.g. within H1 or H2). Not using an UL gap may also be called as cancelling, dropping or discarding the UL gap. The UE may further cancel or discard multiple UL gaps in the configured ULGP if the UE meets one or more GSP conditions for those UL gaps and one or more UL signals belonging to PS1.
The UE 100 may decide to use the at least one UL gap for the UTPM if the UE 100 determines based on the timing relation that none of the GSP conditions is met. In this case, the UE may further use the at least one UL gap for performing the UTPM. The UE may also transmit the at least one UL signal in PS1 as it does not meet any GSP condition.

FIG. 6 schematically illustrates an example of first UL signal (S1) within UL gap, and second UL signal (S2) and third UL signal (S3) which are close to UL gaps. The UE 100 cancels these UL gaps (G1, G2 and G4) and transmits S1, S2 and S3 as they belong to PS1 and meet the GSP condition.

The first set of procedures (PS1) comprises at least one procedure, which requires at least one UL signal transmission, which has higher priority over an UL gap in the configured ULGP. For example, the UE 100 prioritizes the transmission of the higher priority UL signal over the creation or use of the UL gaps if they meet at least one GSP condition. The prioritization of the transmission of the higher priority UL signal is achieved by transmitting that UL signal while cancelling the UL gap. Therefore, the UE may not be able to perform the UTMP in the cancelled gap. In one example, only selected UL gaps for which the UE meets at least one GSP condition are cancelled. In another example, all the UL gaps, which overlap in time during which any procedure belonging to PS1 is performed, are cancelled.

A set of procedures which do not belong to PS1, may be called as a second set of procedure (PS2). PS2 comprises at least one procedure. The difference between PS1 and PS2 is as follows. The UL one or more signals in any procedure belonging to PS2, has lower priority over an UL gap in the configured ULGP. For example, the UE prioritizes the operation of UL gaps over the transmission of any UL signal belonging to any procedure in PS2 regardless of any timing relation between the UL signal of PS2 and the UL gap. Before or during the transmission of any UL signal of PS2, the UE may or may not check any timing relation between the UL signal of PS2 and the UL gaps. The prioritization of the operation of the UL gap is achieved by not cancelling the UL gap, using the UL gap for UTMP etc. Therefore, the UE is able to perform the UTMP in the UL gap regardless of whether the UL signal of PS2 overlaps with the UL gap in time or if it occurs close to the UL gap in time. The UE may further drop or discard or postpone transmission of any UL signal of PS2 which the UE may not be able to transmit e.g. due to overlapping with the UL gap in time or being close to the UL gap in time. In one example, only selected UL signals of PS2 which the UE cannot transmit due to the UL gaps are dropped or postponed. In another example, all the UL signals of PS2, which overlap in time during which that procedure (belonging to PS2) is performed, are dropped or postponed. The UE may further transmit the dropped or postponed UL signal of PS2 in a future time resource.

The UE 100 may further be configured to perform a third set of procedure (PS3). The one or more procedures in PS3 may comprise any operation which requires signal operation (e.g. transmission and/or reception) for the UE TX power management e.g. UTPM. Therefore, PS3 may consists of one or more of body proximity sensing, MPE determination, P-MPR procedure as part of TX power management etc. PS3 may also refer to the procedure or operation when an UL gap of the ULGP is used by the UE for UTPM (e.g., when the UL gaps is not cancelled).

Any aspect and any embodiment may apply at least one of the following rules for determination of PS1 and/or PS2.

Determination of procedures belonging to PS1 and belonging to PS2 is based on one or more rules:
In one example, the UE 100 determines PS1 by obtaining information about one or more procedures in PS1. The UE 100 may further obtain information about UL signals in one or more procedures in PS1 which have higher priority over the UL gaps. In one example, all the UL signals in in one or more procedures PS1 have higher priority over the UL gaps. In another example, subset of the UL signals in one or more procedures in PS1 have higher priority over the UL gaps. In one example, procedures which do not belong to PS1, are assumed to belong to PS2.
In another example the UE determines PS2 by obtaining information about one or more procedures in PS2. In one example, procedures which do not belong to PS2, are assumed to belong to PS1. In one example, all the UL signals in in one or more procedures PS1 have higher priority over the UL gaps.
In another example the UE determines PS1 by obtaining information about one or more procedures in PS1, and also determines PS2 by obtaining information about one or more procedures in PS2.
Alternatively or in addition, the UE 100 further determines PS1 and/or PS2 using any of the following mechanism:
   (A) In one example, the rule is determined based on message received by the network. The message may be received via signaling such as RRC, via MAC-CE or DCI command, etc.
   (B) In one example, rule is determined based on pre-defined information in the specification.

In any aspect and any embodiment may use at least one of the following examples of procedures in PS1.

Specific examples of PS1 during which one or more UL gaps are cancelled when at least one GSP condition is met are described below:
Cell change procedure, e.g. at least one of:
   Handover (HO), RRC re-establishment, RRC connection release with redirection, SpCell addition/release or change, SCell change, HO with PSCell change, etc.
UL CCA operation e.g., when number of UL CCA failures exceed threshold, when number of successful UL CCA exceeds a threshold
When UE changing the serving cell status, e.g. at least one of: SCell activation, SCell deactivation, SCell dormancy (between dormant and non-dormant)
When UE sending UL critical signal to a network node, e.g., at least one of:
   (A) Transmission of the positioning measurement report or results to a location server (e.g. LMF etc). Examples are reporting of RSTD, PRS-RSRP, UE Rx-Tx time difference, measurement results etc.
   (B) Transmission of any UL signal which is implicitly or explicitly related to public safety or emergency situation. Examples are measurement report for assisting cell change to a cell to ensure better quality of signa, higher layer critical information (e.g. sending emergency message), sending positioning measurement data related to emergency call (e.g. RSTD measurement results/report) etc.
   (C) UL transmission (e.g., RACH) for beam failure recovery procedure
   (D) UL transmission (e.g., RACH) for acquiring synchronization e.g., upon expiry of a TA related timer (e.g. time alignment timer (TAT))
   (E) UL transmission (e.g., RACH) in response to a request from the network node e.g. via DL control channel such as PDCCH order
   (F) UL transmission (e.g., RACH) for performing a cell change e.g. handover, SpCell addition/release or change etc.
   (G) UL transmission (e.g., CSI report) for completing a procedure e.g. sending of CSI report (e.g. CQI, CQI with non-zero index, etc.) during SCell activation procedure, sending of CSI report (e.g. CQI, CQI with non-zero index etc) during active TCI state switching procedure, etc.

Examples of priority rules when the UE 100 has to perform PS1, PS2, PS3 procedures during UL gap instance may include at least one of:
In one specific example of the priority rule, while performing HO, UE need to send PRACH preamble to the gNB. If the PRACH occasion and PS3 procedure overlaps during a UL gap occasion (e.g., meet at least one GSP condition), UE shall transmit PRACH preamble without taking the UL gap to perform PS3 procedure. Prioritizing PS3 vs PRACH preamble will result in HO completion delay and resulting in more interruption for the UE data transmissions.
In another specific example of the priority rule, while performing RRC reestablishment, UE need to send PRACH preamble at one point and RRCReestablishmentRequest message to the gNB at another point. If PRACH preamble transmission occasion or UL grant to transmit RRCReestablishmentRequest overlaps with PS3 procedure during a UL gap occasion, UE shall transmit PRACH preamble, RRCReestablishmentRequest without taking the UL gap to perform PS3 procedure. Prioritizing PS3 procedure over PRACH preamble and RRCReestablishmentRequest will result in RRC reestablishment completion delay and resulting in more interruption for the UE data transmissions.
In another specific example of the priority rule, while performing RRC reestablishment with CCA, UE need to send PRACH preamble at one point and RRCReestablishmentRequest message to the gNB at another point. If PRACH preamble transmission occasion or UL grant to transmit RRCReestablishmentRequest overlaps with PS3 procedure during a UL gap occasion, UE shall transmit PRACH preamble, RRCReestablishmentRequest without taking the UL gap to perform PS3 procedure. Prioritizing PS3 procedure over PRACH preamble and RRCReestablishmentRequest will result in RRC reestablishment completion delay and resulting in more interruption for the UE data transmissions.
In another specific example of the priority rule, while performing RRC connection release with redirection, UE need to send PRACH preamble to the redirected cell. If PRACH preamble transmission occasion overlaps with PS3 procedure during a UL gap occasion, UE shall transmit PRACH preamble on the redirected cell, without taking the UL gap to perform PS3 procedure. Prioritizing PS3 procedure over PRACH preamble will result in RRC connection release with redirection and thereby resulting in more interruption for the UE data transmissions.
In another specific example of the priority rule, while performing spCell addition/release, UE need to send PRACH preamble to the added spCell. If PRACH preamble transmission occasion overlaps with PS3 procedure during a UL gap occasion, UE shall transmit PRACH preamble on the added cell, without taking the UL gap to perform PS3 procedure. Prioritizing PS3 procedure over PRACH preamble will result in spCell addition and thereby resulting in lesser throughput for the UE.
In another specific example of the priority rule, while performing SCell activation/deactivation/change or SCell dormancy change (form dormant to non-dormant state or vice-versa), UE need to send CSI report to the SCell/spCell to complete the SCell activation/deactivation/change/SCell dormancy transition. In some other cases, if the SCell is activated with PUCCH, UE need to transmit PRACH preamble to acquire UL synchronization. If CSI reporting instance or PRACH preamble transmission occasion overlaps with PS3 procedure during a UL gap occasion, UE shall transmit CSI report or PRACH preamble to complete the above said SCell procedure without taking the UL gap to perform PS3 procedure. Prioritizing PS3 procedure over CSI report or PRACH preamble will result in SCell activation delay and thereby resulting in capacity drop for the UE.
In another specific example of the priority rule, while performing HO with PSCell change, UE need to send PRACH preamble on the PCell and PSCell at different instances or same instance based on the UE capability. If PRACH preamble transmission occasion on PCell or PSCell overlaps with PS3 procedure during a UL gap occasion, UE shall transmit PRACH preamble on the PCell or PSCell, without taking the UL gap to perform PS3 procedure. Prioritizing PS3 procedure over PRACH preamble will result in delay of HO with PSCell and thereby resulting in lesser throughput for the UE.
In another specific example of the priority rule, if UE operating in unlicensed carrier and number of UL CCA failures exceeds certain threshold, or if the UL CCA is successful, then the UE does not use UL gap to perform PS3 procedure as next CCA success may take time for the UE. Therefore, the UE cancels the UL gap and instead operates the UL signal.
In another specific example of the priority rule, while performing RACH during beam failure recovery or performing RACH when TA timer expires (e.g. TAT expired) or performing RACH based on PDCCH order, UE need to send PRACH preamble to the gNB. If PRACH preamble transmission occasion in the above said scenarios overlaps with PS3 procedure during a UL gap occasion, UE shall transmit PRACH preamble without taking the UL gap to perform PS3 procedure. Prioritizing PS3 procedure over PRACH preamble will result in system performance degradation.
In another specific example of the priority rule, while performing positioning measurement for example for public safety applications, UE need to send positioning measurement report to the gNB. If the positioning measurement report occasion overlaps with PS3 procedure during a UL gap occasion, UE shall transmit positioning measurement report to gNB without taking the UL gap to perform PS3 procedure. Prioritizing PS3 procedure over positioning measurement report will result in degraded public safety performance.

In one variant of the first detailed embodiment, the above-described priority rules may be supported by all the UEs (e.g., UEs 100) supporting UTPM.

In another variant of first detailed embodiment, the above-described priority rules may be supported by only a few UEs supporting UTPM and this capability may be indicated to the gNB 200 by the UE 100.

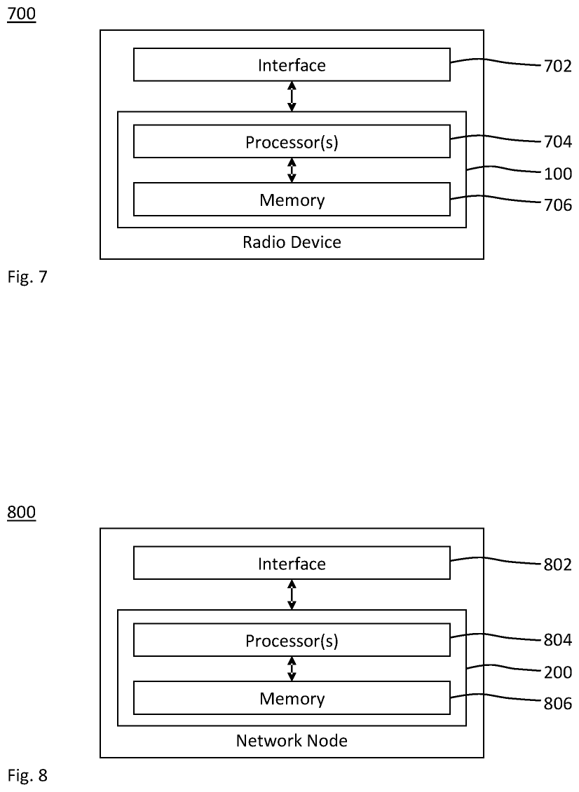

FIG. 7 shows a schematic block diagram for an embodiment of the device 100. The device 100 comprises processing circuitry, e.g., one or more processors 704 for performing the method 300 and memory 706 coupled to the processors 704. For example, the memory 706 may be encoded with instructions that implement at least one of the modules 102 and 104.

The one or more processors 704 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 706, radio device functionality. For example, the one or more processors 704 may execute instructions stored in the memory 706. Such functionality may include providing various features and steps discussed herein, including any of the benefits disclosed herein. The expression “the device being operative to perform an action” may denote the device 100 being configured to perform the action.

As schematically illustrated in FIG. 7, the device 100 may be embodied by a radio device 700, e.g., functioning as a UE. The radio device 700 comprises a radio interface 702 coupled to the device 100 for radio communication with one or more network node, e.g., functioning as a base station or gNB.

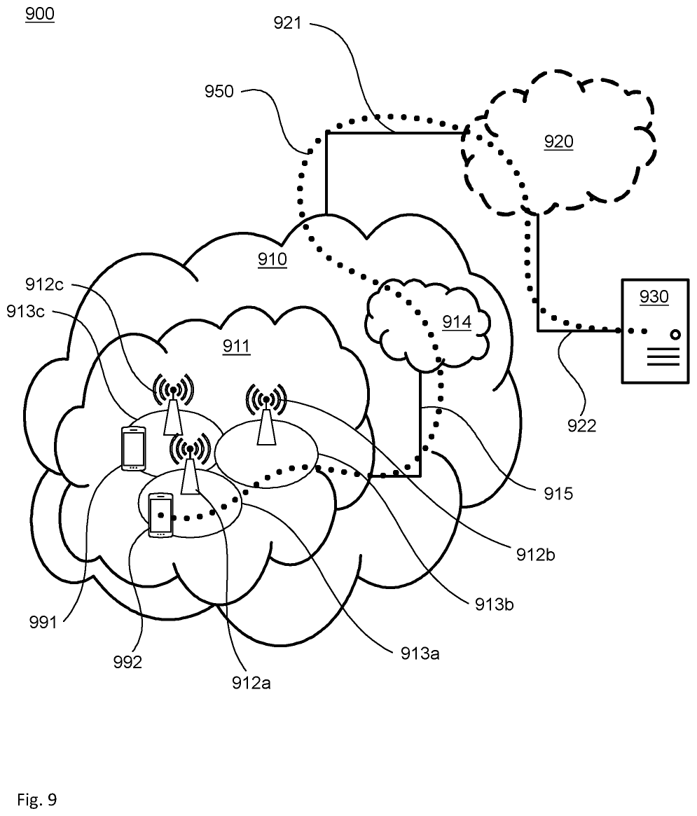

FIG. 8 shows a schematic block diagram for an embodiment of the device 200. The device 200 comprises processing circuitry, e.g., one or more processors 804 for performing the method 400 and memory 806 coupled to the processors 804. For example, the memory 806 may be encoded with instructions that implement at least one of the modules 202 and 204.

The one or more processors 804 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 806, network node functionality. For example, the one or more processors 804 may execute instructions stored in the memory 806. Such functionality may include providing various features and steps discussed herein, including any of the benefits disclosed herein. The expression “the device being operative to perform an action” may denote the device 200 being configured to perform the action.

As schematically illustrated in FIG. 8, the device 200 may be embodied by a network node 800, e.g., functioning as a base station or gNB. The network node 800 comprises a radio interface 802 coupled to the device 200 for radio communication with one or more radio devices, e.g., functioning as a UE.

With reference to FIG. 9, in accordance with an embodiment, a communication system 900 includes a telecommunication network 910, such as a 3GPP-type cellular network, which comprises an access network 911, such as a radio access network, and a core network 914. The access network 911 comprises a plurality of base stations 912a, 912b, 912c, such as NBs, eNBs, gNBs or other types of wireless access points, each defining a corresponding coverage area 913a, 913b, 913c. Each base station 912a, 912b, 912c is connectable to the core network 914 over a wired or wireless connection 915. A first user equipment (UE) 991 located in coverage area 913c is configured to wirelessly connect to, or be paged by, the corresponding base station 912c. A second UE 992 in coverage area 913a is wirelessly connectable to the corresponding base station 912a. While a plurality of UEs 991, 992 are illustrated in this example, the disclosed embodiments are equally applicable to a situation where a sole UE is in the coverage area or where a sole UE is connecting to the corresponding base station 912.

Any of the base stations 912 and the UEs 991, 992 may embody the device 200 and the device 100, respectively.

The telecommunication network 910 is itself connected to a host computer 930, which may be embodied in the hardware and/or software of a standalone server, a cloud-implemented server, a distributed server or as processing resources in a server farm. The host computer 930 may be under the ownership or control of a service provider, or may be operated by the service provider or on behalf of the service provider. The connections 921, 922 between the telecommunication network 910 and the host computer 930 may extend directly from the core network 914 to the host computer 930 or may go via an optional intermediate network 920. The intermediate network 920 may be one of, or a combination of more than one of, a public, private or hosted network; the intermediate network 920, if any, may be a backbone network or the Internet; in particular, the intermediate network 920 may comprise two or more sub-networks (not shown).

The communication system 900 of FIG. 9 as a whole enables connectivity between one of the connected UEs 991, 992 and the host computer 930. The connectivity may be described as an over-the-top (OTT) connection 950. The host computer 930 and the connected UEs 991, 992 are configured to communicate data and/or signaling via the OTT connection 950, using the access network 911, the core network 914, any intermediate network 920 and possible further infrastructure (not shown) as intermediaries. The OTT connection 950 may be transparent in the sense that the participating communication devices through which the OTT connection 950 passes are unaware of routing of uplink and downlink communications. For example, a base station 912 need not be informed about the past routing of an incoming downlink communication with data originating from a host computer 930 to be forwarded (e.g., handed over) to a connected UE 991. Similarly, the base station 912 need not be aware of the future routing of an outgoing uplink communication originating from the UE 991 towards the host computer 930.

By virtue of the method 300 being performed by any one of the UEs 991 or 992 and/or the method 400 being performed by any one of the base stations 912, the performance or range of the OTT connection 950 can be improved, e.g., in terms of increased throughput and/or reduced latency. More specifically, the host computer 930 may indicate to the RAN 500 or the radio device 100 or the network node 200 (e.g., on an application layer) the QoS of the traffic, which may trigger performing the methods 300 and/or 400.

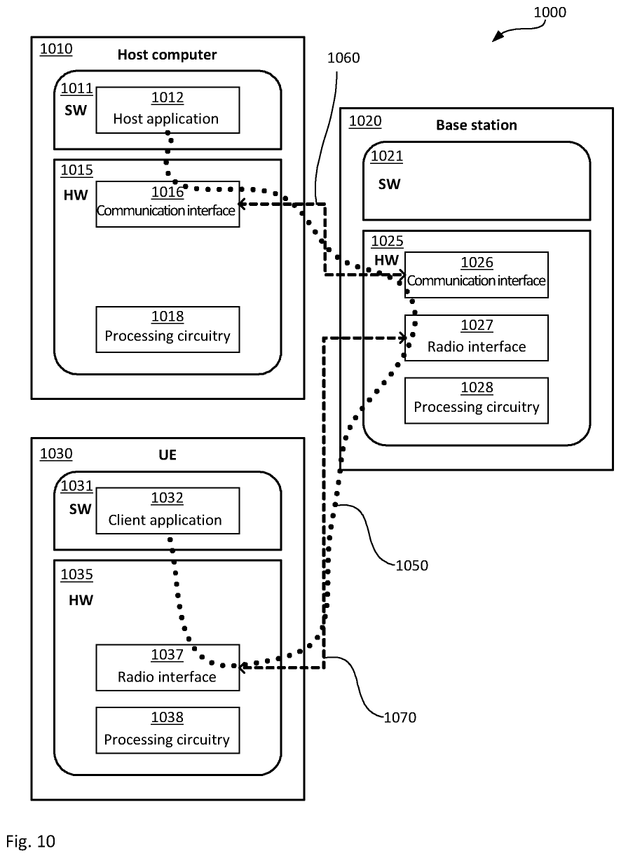

Example implementations, in accordance with an embodiment of the UE, base station and host computer discussed in the preceding paragraphs, will now be described with reference to FIG. 10. In a communication system 1000, a host computer 1010 comprises hardware 1015 including a communication interface 1016 configured to set up and maintain a wired or wireless connection with an interface of a different communication device of the communication system 1000. The host computer 1010 further comprises processing circuitry 1018, which may have storage and/or processing capabilities. In particular, the processing circuitry 1018 may comprise one or more programmable processors, application-specific integrated circuits, field programmable gate arrays or combinations of these (not shown) adapted to execute instructions. The host computer 1010 further comprises software 1011, which is stored in or accessible by the host computer 1010 and executable by the processing circuitry 1018. The software 1011 includes a host application 1012. The host application 1012 may be operable to provide a service to a remote user, such as a UE 1030 connecting via an OTT connection 1050 terminating at the UE 1030 and the host computer 1010. In providing the service to the remote user, the host application 1012 may provide user data, which is transmitted using the OTT connection 1050. The user data may depend on the location of the UE 1030. The user data may comprise auxiliary information or precision advertisements (also: ads) delivered to the UE 1030. The location may be reported by the UE 1030 to the host computer, e.g., using the OTT connection 1050, and/or by the base station 1020, e.g., using a connection 1060.

The communication system 1000 further includes a base station 1020 provided in a telecommunication system and comprising hardware 1025 enabling it to communicate with the host computer 1010 and with the UE 1030. The hardware 1025 may include a communication interface 1026 for setting up and maintaining a wired or wireless connection with an interface of a different communication device of the communication system 1000, as well as a radio interface 1027 for setting up and maintaining at least a wireless connection 1070 with a UE 1030 located in a coverage area (not shown in FIG. 10) served by the base station 1020. The communication interface 1026 may be configured to facilitate a connection 1060 to the host computer 1010. The connection 1060 may be direct, or it may pass through a core network (not shown in FIG. 10) of the telecommunication system and/or through one or more intermediate networks outside the telecommunication system. In the embodiment shown, the hardware 1025 of the base station 1020 further includes processing circuitry 1028, which may comprise one or more programmable processors, application-specific integrated circuits, field programmable gate arrays or combinations of these (not shown) adapted to execute instructions. The base station 1020 further has software 1021 stored internally or accessible via an external connection.

The communication system 1000 further includes the UE 1030 already referred to. Its hardware 1035 may include a radio interface 1037 configured to set up and maintain a wireless connection 1070 with a base station serving a coverage area in which the UE 1030 is currently located. The hardware 1035 of the UE 1030 further includes processing circuitry 1038, which may comprise one or more programmable processors, application-specific integrated circuits, field programmable gate arrays or combinations of these (not shown) adapted to execute instructions. The UE 1030 further comprises software 1031, which is stored in or accessible by the UE 1030 and executable by the processing circuitry 1038. The software 1031 includes a client application 1032. The client application 1032 may be operable to provide a service to a human or non-human user via the UE 1030, with the support of the host computer 1010. In the host computer 1010, an executing host application 1012 may communicate with the executing client application 1032 via the OTT connection 1050 terminating at the UE 1030 and the host computer 1010. In providing the service to the user, the client application 1032 may receive request data from the host application 1012 and provide user data in response to the request data. The OTT connection 1050 may transfer both the request data and the user data. The client application 1032 may interact with the user to generate the user data that it provides.

It is noted that the host computer 1010, base station 1020 and UE 1030 illustrated in FIG. 10 may be identical to the host computer 930, one of the base stations 912a, 912b, 912c and one of the UEs 991, 992 of FIG. 9, respectively. This is to say, the inner workings of these entities may be as shown in FIG. 10, and, independently, the surrounding network topology may be that of FIG. 9.

In FIG. 10, the OTT connection 1050 has been drawn abstractly to illustrate the communication between the host computer 1010 and the UE 1030 via the base station 1020, without explicit reference to any intermediary devices and the precise routing of messages via these devices. Network infrastructure may determine the routing, which it may be configured to hide from the UE 1030 or from the service provider operating the host computer 1010, or both. While the OTT connection 1050 is active, the network infrastructure may further take decisions by which it dynamically changes the routing (e.g., on the basis of load balancing consideration or reconfiguration of the network).

The wireless connection 1070 between the UE 1030 and the base station 1020 is in accordance with the teachings of the embodiments described throughout this disclosure. One or more of the various embodiments improve the performance of OTT services provided to the UE 1030 using the OTT connection 1050, in which the wireless connection 1070 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1050 between the host computer 1010 and UE 1030, in response to variations in the measurement results. The measurement procedure and/or the network functionality for reconfiguring the OTT connection 1050 may be implemented in the software 1011 of the host computer 1010 or in the software 1031 of the UE 1030, or both. In embodiments, sensors (not shown) may be deployed in or in association with communication devices through which the OTT connection 1050 passes; the sensors may participate in the measurement procedure by supplying values of the monitored quantities exemplified above, or supplying values of other physical quantities from which software 1011, 1031 may compute or estimate the monitored quantities. The reconfiguring of the OTT connection 1050 may include message format, retransmission settings, preferred routing etc.; the reconfiguring need not affect the base station 1020, and it may be unknown or imperceptible to the base station 1020. Such procedures and functionalities may be known and practiced in the art. In certain embodiments, measurements may involve proprietary UE signaling facilitating the host computer's 1010 measurements of throughput, propagation times, latency and the like. The measurements may be implemented in that the software 1011, 1031 causes messages to be transmitted, in particular empty or “dummy” messages, using the OTT connection 1050 while it monitors propagation times, errors etc.

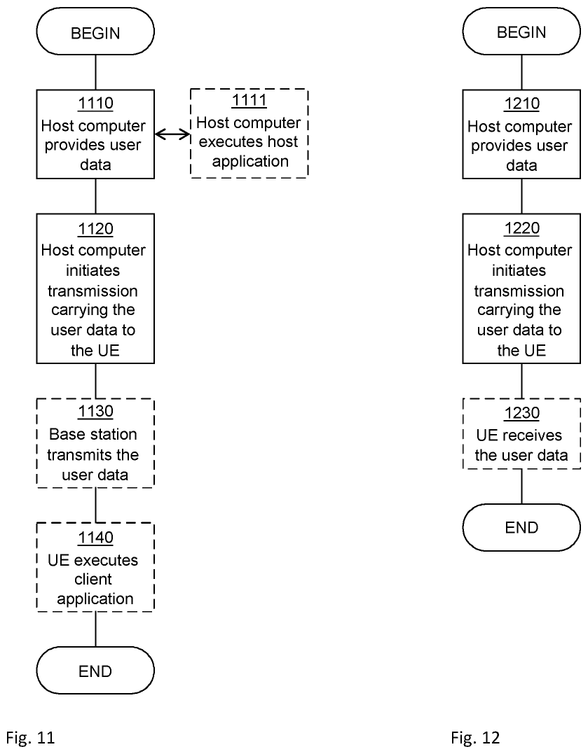

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this paragraph. In a first step 1110 of the method, the host computer provides user data. In an optional substep 1111 of the first step 1110, the host computer provides the user data by executing a host application. In a second step 1120, the host computer initiates a transmission carrying the user data to the UE. In an optional third step 1130, the base station transmits to the UE the user data which was carried in the transmission that the host computer initiated, in accordance with the teachings of the embodiments described throughout this disclosure. In an optional fourth step 1140, the UE executes a client application associated with the host application executed by the host computer.

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this paragraph. In a first step 1210 of the method, the host computer provides user data. In an optional substep (not shown) the host computer provides the user data by executing a host application. In a second step 1220, the host computer initiates a transmission carrying the user data to the UE. The transmission may pass via the base station, in accordance with the teachings of the embodiments described throughout this disclosure. In an optional third step 1230, the UE receives the user data carried in the transmission.

As has become apparent from above description, at least some embodiments of the technique enhance an overall performance of procedures involving setting up or change of multiple serving cells. Performance of multiple SCell activation, multiple PUCCH SCell activation, and/or handover with PSCell change, etc., can be improved, e.g. since the radio device (e.g., UE) can complete them within less or a specified time.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1. A method performed by a radio device for an uplink transmit power management (UTPM) procedure, the method comprising or initiating:
determining a timing relation between a timing of at least one uplink (UL) gap for the UTPM procedure and a timing of at least one UL signal belonging to a procedure in a first set of procedures (PS1); and
selectively using the at least one UL gap for the UTPM procedure depending on the determined timing relation.

2. The method of claim 1, wherein the radio device is configured with at least one UL gap pattern, (ULGP) comprising the at least one UL gap for performing the UTPM procedure.

3. The method of claim 1, wherein the UTPM procedure comprises at least one of:
calibration or self-calibration of a power amplifier (PA) of the radio device;
a proximity detection or body proximity sensing (BPS) at the radio device;
a power management maximum power reduction (P-MPR) of a transmit power of the radio device; or
a P-MPR that depends on a proximity of a body to the radio device.

4. The method of claim 1, wherein the at least one UL gap for performing the UMTP is a gap in an UL transmission of the radio device.

5. The method of claim 1, wherein the radio device transmits an UL signal when the at least one UL gap is not used for the UTPM procedure.

6. The method of claim 1, wherein the radio device determines whether or not to use the at least one UL gap based on the determined timing relation.

7. The method of claim 1, wherein the PS1 or each procedure in the PS1 or the at least one UL signal belonging to the procedure in the PS1 is associated with a PS1 priority that is higher than a PS3 priority.

8. The method of claim 7, wherein the radio device cancels the at least one UL gap and/or transmits the at least one UL signal belonging to the procedure in the PS1 in the at least one UL gap, if at least one of the following conditions is fulfilled:
if the at least one UL signal belonging to the procedure in the PS1 overlaps in time with the at least one UL gap;
if the at least one UL gap occurs during the procedure in the PS1; and
if the at least one UL signal belonging to the procedure in the PS1 and the UL gap are close in time to each other or are closer in time to each other than a predefined threshold.

9. The method of claim 1, wherein the radio device performs, or is configured to perform, one or more procedures in a second set of procedures, PS2, wherein each procedure in the PS2 comprises transmitting at least one UL signal belonging to the respective procedure in the PS2, and wherein a PS2 priority is lower than the PS1 priority and/or lower than a or the PS3 priority.

10. The method of claim 9, wherein the radio device performs the UTPM procedure or one or more UTPM procedures in the PS3 and/or drops or postpones the transmission of the at least one UL signal belonging to a procedure in the PS2 in the at least one UL gap, if at least one of the following conditions is fulfilled:
if the at least one UL signal belonging to the procedure in the PS2 overlaps in time with the at least one UL gap;
if the at least one UL gap occurs during the procedure in the PS2; and
if the at least one UL signal belonging to the procedure in the PS2 and the UL gap are close in time to each other or are closer in time to each other than a predefined threshold.

11. The method of claim 7, wherein the PS3 priority is associated with at least one or each of:
the at least one UL gap;
the ULGP; and
the one or more UL gaps of the ULGP,
or wherein the PS3 priority is associated with at least one of, or a third set of procedures, PS3, comprising at least one of:
the UTPM procedure;
the UTPM procedure performed during UL gaps; and
a procedure that is related to the UTPM and/or performed during UL gaps.

12. The method of claim 1, wherein the PS1 comprises at least one of the following procedures:
a cell change;
a cell selection;
a handover, HO;
a dual active protocol stack HO, DAPS HO,
a conditional HO, CHO;
transmitting emergency information;
transmitting an UL signal related to a beam failure recovery;
a random access procedure during a cell change;
a random access channel, RACH, transmission for acquisition of synchronization;
a random access channel, RACH, transmission upon expiry of a time alignment timer, TAT;
a radio resource control, RRC, reestablishment;
an RRC connection release;
activation of a secondary cell, SCell;
deactivation of an SCell;
dormancy of an SCell;
transmitting a channel state information, CSI, report, and/or a channel quality indicator, CQI;
transmission of positioning measurement report;
UL transmission after or based on the outcome of a clear channel assessment, CCA, procedure on a carrier subject to CCA; and
attempting transmission in an unlicensed carrier,
and/or wherein the at least one UL signal belonging to the respective procedure in the PS1 comprises or is indicative of at least one of:
emergency information;
a beam failure recovery;
a random access preamble, RAP;
a RAP for acquisition of synchronization;
an RRC reestablishment request;
a response to a command for activation of an SCell;
a CSI report and/or a CQI;
a positioning measurement report.

13. The method of claim 1, wherein at least one of:
the least one UL signal belonging to the or each procedure in the PS1 and
the least one UL signal-belonging to the or each procedure in the PS2
is performed in a frequency range 2, FR2, or in a frequency range from 24250 MHz to 71000 MHz, or in a frequency range FR2-1, or in a frequency range from 24250 MHz to 52600 MHz, or in a frequency range FR2-2, or a frequency range from 52600 MHz to 71000 MHz, or in millimeter wave band, or in a frequency range 3, FR3, or in a frequency range from 7125 MHz and 24250 MHz.

14. The method of claim 1, wherein a signal belonging to the UTPM procedure or each procedure in the PS3 is a radio detection and ranging signal, radar signal and/or
wherein the UTPM procedure or each procedure in the PS3 uses in the at least one UL gap a frequency range outside of at least one of:
the least one UL signal belonging to the or each procedure in the PS1 and
the least one UL signal belonging to the or each procedure in the PS2.

15. The method of claim 1, wherein the UL signal is transmitted, or is to be transmitted, from the radio device to a network node.

16. A method performed by a network node for configuring a radio device for an uplink transmit power management (UTPM) procedure, the method comprising or initiating:
determining, or configuring the radio device to determine, a timing relation between a timing of at least one uplink (UL) gap for the UTPM procedure and a timing of at least one UL signal belonging to a procedure in a first set of procedures (PS1); and
selectively scheduling the radio device with the at least one UL signal during the at least one UL gap depending on the determined timing relation or configuring the radio device to selectively use the at least one UL gap for the UTPM procedure depending on the determined timing relation.

17. The method of claim 16, wherein the radio device is scheduled with the at least one UL signal belonging to the procedure in the PS1 in the at least one UL gap, if at least one of the following conditions is fulfilled:
if the at least one UL signal belonging to the procedure in the PS1 overlaps in time with the at least one UL gap;
if the at least one UL gap occurs during the procedure in the PS1; and
if the at least one UL signal belonging to the procedure in the PS1 and the UL gap are close in time to each other or are closer in time to each other than a predefined threshold.

18-23. (canceled)

24. A user equipment (UE) for an uplink transmit power management (UTPM) procedure, the UE being configured to communicate with a base station or with a radio device functioning as a gateway, the UE comprising:
a radio interface; and
processing circuitry, wherein the UE is configured to:
determine a timing relation between a timing of at least one uplink (UL) gap for the UTPM procedure and a timing of at least one UL signal belonging to a procedure in a first set of procedures (PS1); and
selectively use the at least one UL gap for the UTPM procedure depending on the determined timing relation.

25-29. (canceled)

30. A base station for configuring a radio device for an uplink transmit power management (UTPM) procedure, the base station being configured to communicate with a user equipment (UE), the base station comprising:
a radio interface; and
processing circuitry, wherein the base station is configured to:
determine, or configuring the radio device to determine, a timing relation between a timing of at least one uplink (UL) gap for the UTPM procedure and a timing of at least one UL signal belonging to a procedure in a first set of procedures; and
selectively schedule the radio device with the at least one UL signal during the at least one UL gap depending on the determined timing relation or configure the radio device to selectively use the at least one UL gap for the UTPM procedure depending on the determined timing relation.

31-36. (canceled)
